(19) United States
(12) Patent Application Publication
(10) Pub. No.: US 2008/0047406 A1
(43) Pub. Date: Feb. 28, 2008

(54) Bevel Angle Locking Actuator and Bevel Angle Locking System for a Saw

(76) Inventors: Michael Chad Hollis, Huron, TN (US); Craig Allen Carroll, Milan, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/931,575

(22) Filed: Oct. 31, 2007

Related U.S. Application Data
(63) Continuation of application No. 10/717,536, filed on Nov. 21, 2003.
(60) Provisional application No. 60/428,931, filed on Nov. 26, 2002.

(51) Int. Cl. B26D 1/00

(52) U.S. Cl. 83/13; 83/581

(57) ABSTRACT

A benchtop saw, such as a compound miter saw, has a bevel angle locking actuator for locking the bevel angle of the saw blade which is easier for the operator to reach than prior art bevel angle locking actuators that are located at the rear of the saw. The bevel angle locking actuator is mounted forward of the rear of the saw on the saw support assembly, which is in turn rotatably mounted to the saw's base assembly. Also disclosed is a bevel angle locking system which permits remote mounting of a bevel angle locking actuator.

This application is a continuation of, claims priority to, and incorporates by reference in its entirety, the following U.S. patent application Ser. No. 10/717,536, entitled “BEVEL ANGLE LOCKING ACTUATOR AND BEVEL ANGLE LOCKING SYSTEM FOR A SAW” filed Nov. 21, 2003, which claims priority from U.S. provisional patent application Ser. No. 60/428,931 filed on Nov. 26, 2002.

### BACKGROUND

This invention generally relates to bench top saws that permit adjustment of the bevel angle of cut, including, but not limited to compound miter saws. This invention provides a bevel angle locking actuator and bevel angle locking system for locking the saw at a desired bevel angle.

Bench top saws are characterized by the ability to place the saw on a surface and use the saw to cut a workpiece while the saw is being supported on the surface. The surface could be a table or bench top, floor, etc.

Compound miter saws typically comprise a base assembly having a turntable rotatably mounted on a base to turn about a vertical axis, and a saw support assembly pivotally mounted to the turntable to turn about a horizontal axis where the vertical axis is normal to the top surface of the base assembly and the horizontal axis is parallel with the top surface of the base assembly. Miter saws also typically comprise a saw unit pivotally mounted to the saw support assembly to plunge a saw blade into a workpiece resting on the base assembly. The saw blade of the saw unit turns to cut the workpiece, and defines a cutting plane that is parallel with the horizontal axis. The base assembly also typically has a fence attached to the base for aligning a workpiece on the base assembly and holding it in position during a cut.

A compound miter saw permits compound angle cuts to be made on a workpiece. The compound angle cut of a compound miter saw includes a miter angle component and a bevel angle component. The miter angle is the angle of cut adjusted by rotating the turntable and the saw blade about the vertical axis. The bevel angle is the angle of cut adjusted by rotating the saw support assembly and the saw blade about the horizontal axis. The compound miter saw permits the operator to independently adjust both the miter angle and the bevel angle to make the desired compound angle cut. The operator may also adjust solely the miter angle or the bevel angle to make a simpler cut with only a miter angle or bevel angle component.

Other types of bench top saws besides compound miter saws also permit adjustment of the bevel angle of cut, and the invention is applicable to these saws, as well. For example, a saw which permits adjustment of the bevel angle but not of the miter angle may include a saw support assembly mounted to a base (without a turntable), where the saw support assembly pivots about a horizontal axis relative to the base to adjust the bevel angle of cut. As another example, a saw which permits adjustment of both the bevel angle and the miter angle, but is different from typical compound miter saws, may include a saw support assembly mounted to a base, where the saw support assembly pivots about a horizontal axis relative to the base to adjust the bevel angle of cut, and may include a fence which is adjustably mounted on the base to adjust the miter angle of cut.

In order to set-up a typical compound miter saw for a cut including a bevel angle component, the bevel angle is first adjusted by rotating the saw support assembly and the saw unit about the horizontal axis to the desired bevel angle. The saw support assembly must then be locked relative to the base assembly to retain the desired bevel angle while the cut is performed. Prior art bevel angle locking systems typically clamp together opposing surfaces of the saw support assembly and the base assembly to hold the bevel angle with friction. The bevel angle locking system described in U.S. Pat. No. 5,235,889 (“the '889 patent”) is illustrative. Typically these bevel angle locking systems have comprised a shaft or pin anchored to the base assembly, such as shaft 81 in FIG. 7 of the '889 patent. The shaft or pin extends from the base assembly and projects through the saw support assembly. A handle or nut is attached onto the end of the shaft or pin, such as handle 78 in FIG. 7 of the '889 patent. When the handle is turned, the saw support assembly is pushed against the base assembly and friction prevents the saw support assembly from rotating relative to the base assembly.

One drawback of the type of bevel angle locking system described above is that the actuator, the handle or nut, is located at the rear of the saw. The operator must reach around to the back of the saw to loosen or tighten the handle or nut for unlocking or locking the bevel angle, a task which is often awkward and cumbersome.

One advantageous feature of the present invention is an actuator for locking the bevel angle provided in a position forward of the rear of the saw, a position where an operator may more easily access the actuator. This feature and other advantageous features of the invention will be described hereinafter with reference to the illustrative embodiments of the invention depicted in the drawing figures.

### BRIEF DESCRIPTION OF THE DRAWING FIGURES

FIG. 1 is an isometric view of an exemplary compound miter saw incorporating an illustrative embodiment of the bevel angle locking actuator and an illustrative embodiment of the bevel angle locking system of the present invention.

FIG. 2 is an isometric view of the bevel angle locking actuator and bevel angle locking system of FIG. 1 in an unlocked position.

FIG. 3 is a detail, plan view of the bevel angle locking system in the same position as in FIG. 2.

FIG. 4 is an isometric view of the bevel angle locking actuator and bevel angle locking system of FIG. 1 in a locked position.

FIG. 5 is a detail, plan view of the bevel angle locking system in the same position as in FIG. 4.

FIG. 6 is an exploded view of some of the components of the illustrative bevel angle locking actuator and illustrative bevel angle locking system of the present invention.

### DETAILED DESCRIPTION

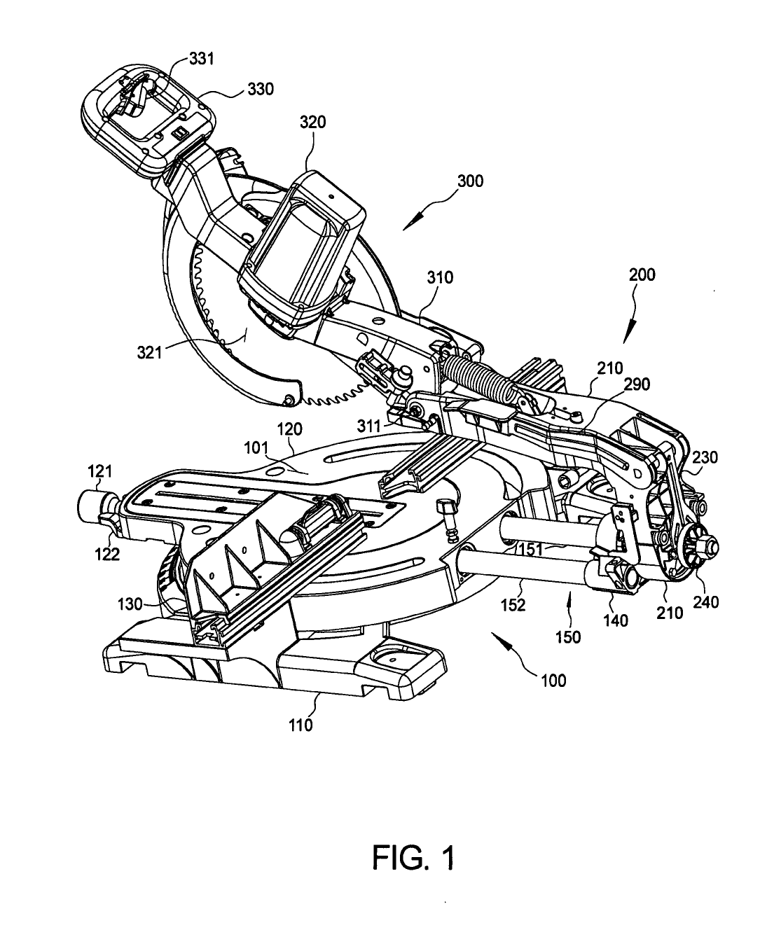

An exemplary compound miter saw is shown in FIGS. 1-6. The principles of the invention described herein may be applied in a similar manner to any type of compound miter saw, or to any type of bench top saw which permits adjustment of the bevel angle of cut. A bench top saw is a saw which can be placed on a surface and used to cut a workpiece while the saw is supported on the surface.

An illustrative embodiment of a bevel angle locking actuator and an illustrative embodiment of a bevel angle locking system are incorporated into the compound miter saw shown in FIGS. 1-6. It should be understood that the principles of the invention are capable of being practiced in other embodiments dissimilar in certain respects to the illustrated embodiments depicted in the drawing figures. The illustrative embodiments will be used to teach the principles of the invention, but the scope of the invention is not intended to be limited to the illustrative embodiments. In particular, it should be understood that the illustrative bevel locking actuator may be used with a bevel locking system different from the one shown in the drawing figures, and vice et versa.

An exemplary compound miter saw is shown in FIG. 1 comprising a base assembly 100 which can include a base 110 and a turntable 120. The turntable 120 is rotatably supported by the base 110 to turn about a vertical axis of rotation. The vertical axis of rotation of the turntable 120 is approximately normal to the top surface 101 of the base assembly 100. The base 110 may be placed upon and supported by a surface such as a table or bench top, or floor during use of the saw. A handle 121 can be grasped by the user to rotate the turntable 120 on the base 110 about the vertical axis to adjust the miter angle of cut. A miter lock is provided to lock the turntable 120 at a desired miter angle. A detent system may also be provided for assisting the operator in adjusting the turntable 120 to commonly used miter angles. The detent system may have an override actuator 122, commonly a lever, mounted in close proximity to the handle 121.

The base assembly 100 may also include a fence assembly 130. The fence assembly 130 may be mounted to the base 110 and overlap a portion of the turntable 120, as shown in FIG. 1. A top surface 101 of the base assembly 100 and the front surface of the fence assembly 130 together support a workpiece during cutting.

A saw support assembly 200 is rotationally mounted to the base assembly 100 at the turntable 120 to rotate about a horizontal first rotational axis. The saw support assembly 200 is rotationally mounted so that the first rotational axis is approximately parallel to the top surface 101 of the base assembly 100, and may also be approximately coplanar with the top surface 101. The saw support assembly 200 rotates relative to the base assembly 100 to adjust the bevel angle of cut.

In this illustrative embodiment, the rotational connection of the saw support assembly 200 to the base assembly 100 is made at a knuckle 140. The knuckle 140 has a female conical surface 141 formed thereon. The saw support assembly 200 has a male conical surface 221 formed thereon. The female conical surface 141 and the male conical surface 221 are in contact with one another and support the saw support assembly 200 for rotational movement. This type of rotational mounting for a saw support assembly with a male and female conical surface, sometimes called a trunnion, is described in U.S. Pat. No. 5,235,889. Of course, the location of the male and female conical surface could be reversed with the male conical surface being formed on the base assembly 100 and the female conical surface being formed on the saw support assembly 200.

Other arrangements for rotationally mounting the saw support assembly 200 to the base assembly 100 which permit adjustment of the bevel angle are also possible and the principles of this invention may apply to miter saws with those other arrangements, as well. For example, some miter saws, such as the one illustrated in U.S. Pat. No. 5,425,294, use flat surfaces on the base assembly and the saw support assembly as well as a pin to rotationally support the saw support assembly on the base assembly (see FIG. 10 of the '294 patent). Other miter saws may simply use a pin extending from the base assembly to the saw support assembly to rotationally support the saw support assembly.

A saw unit 300 is pivotally mounted to the saw support assembly 200. In the illustrated embodiment, the saw unit 300 may include an upper arm 310. The saw support assembly 200 may include a lower arm 210. The upper arm 310 and the lower arm 210 are pivotally connected with a pin 311. The saw unit 300 mounts a saw motor 320 which drives a saw blade 321. The saw blade 321 turns at a high speed to cut the workpiece and defines a cutting plane. The cutting plane is at least approximately parallel to the first rotational axis of saw support assembly 200, and may be approximately coplanar with the first rotational axis. Also, the pivoting axis of upper arm 310 relative to the lower arm 210 is approximately normal to the cutting plane of saw blade 321. The saw support assembly 200 and the saw unit 300 rotate together, in unison, about the first rotational axis when the bevel angle of the saw blade 321 is adjusted.

The saw support assembly 200 pivots the saw unit 300 about pin 311 to plunge the saw blade 321 into a workpiece resting on the top surface 101 of the base assembly 100. A handle 330 is connected to the saw unit 300 and is graspable by the user to control the plunging of the saw blade 321 into the workpiece. The handle 330 includes a power switch 331 for actuating the saw motor 320.

The base assembly 100, the saw support assembly 200, or even perhaps the saw unit 300 may also include a slide mechanism which permits the saw blade 321 to translate relative to the top surface 101. In the illustrated embodiment, the slide mechanism 150 is part of the base assembly 100. The slide mechanism comprises two slide rods 151, 152. The slide rods 151, 152 are supported by and slide out from the turntable 120 in a known manner. The knuckle 140 is mounted to the end of slide rods 151, 152. A slide mechanism may instead be part of a saw support assembly. In that case, a knuckle can be directly mounted to a turntable, or can be integrally formed with a turntable.

As discussed above, in the exemplary embodiment of the compound miter saw, the saw support assembly 200 comprises a lower arm 210. The saw support assembly may include other structure in addition to, or in place of the lower arm 210 to pivotally attach to the base assembly 100 and provide support to the saw unit 300 above the base assembly. Likewise, in the exemplary embodiment of the compound miter saw the saw unit 300 comprises an upper arm 310. However, the saw unit 300 may include other structure in addition to, or in place of the upper arm 310 to attach to the saw support assembly 200 and support the saw motor 320, saw blade 321, and handle 330.

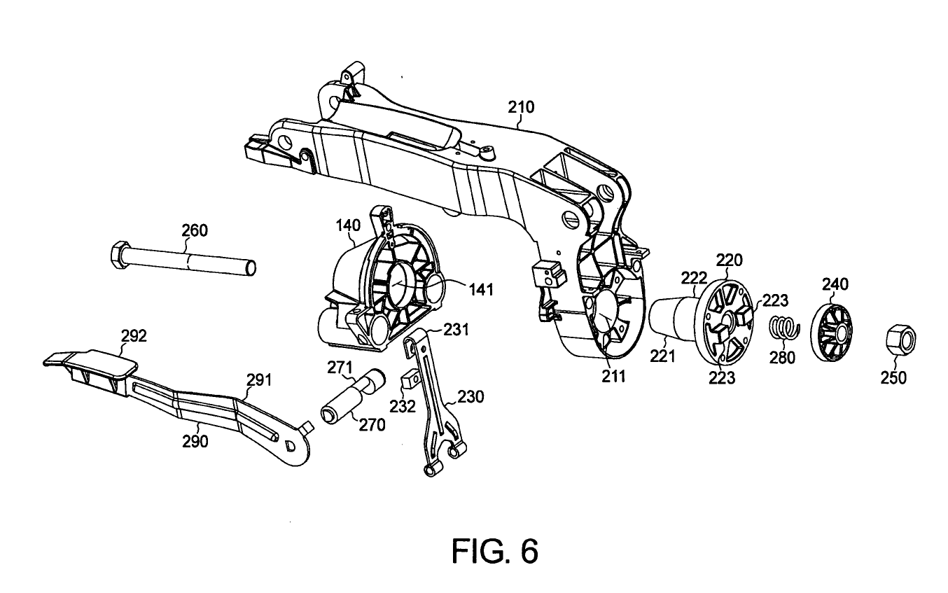

As shown in FIG. 6, in the illustrated embodiment the male conical surface 221 of the saw support assembly 200 is formed on a trunnion insert 220. The trunnion insert 220 is attached to the lower arm 210 during assembly of the miter saw with threaded fasteners (not shown). The trunnion insert 220 includes a cylindrical portion 222 on the end of which is formed the male conical surface 221. The cylindrical portion 222 engages a bore 211 formed through the lower arm 210 in such a manner that the male conical surface 221 extends out from the lower arm 210 towards the knuckle 140. One advantage of forming the male conical surface 221 on the trunnion insert 220 is simplified machining. The male conical surface 221 can be more easily machined on the relatively small trunnion insert 220 than on the lower arm 210. Another advantage is that the trunnion insert 220 can be formed from a different material than the rest of the lower arm 210. For example, the lower arm 210 could be formed from cast aluminum, while the trunnion insert 220 can be formed from cast iron. Aluminum on aluminum wear surfaces can be problematic. If the knuckle 140, including the female conical surface 141, is formed from cast aluminum, it may be advantageous to form the male conical surface on a separate cast iron trunnion insert 220 rather than on the cast aluminum lower arm 210 to avoid aluminum on aluminum wear surfaces—and still manufacture the lower arm from cast aluminum to minimize weight. The advantages of a separate insert on the saw support assembly 200 on which is formed the surface that contacts the base assembly 100 can be realized whether the contact surface is a conical surface, or a straight surface. Of course, despite the disadvantages, the contact surface could be directly formed on the lower arm 210.

The compound miter saw of FIGS. 1-6 includes an illustrative embodiment of a bevel angle locking actuator 290. The bevel angle locking actuator 290 is mounted to the saw support assembly 200 so that the bevel angle locking actuator 290 rotates in unison with the saw support assembly about the first rotational axis when the bevel angle is adjusted. Positioning the bevel angle locking actuator 290 on the saw support assembly 200 presents several advantages over previous designs where the bevel angle locking actuator was mounted at the rear of the saw. The bevel angle locking actuator 290 is more easily accessible to the operator of the saw when mounted to the saw support assembly 200. When the bevel angle locking actuator was mounted at the rear of a compound miter saw, reaching around to lock the bevel angle sometimes required extreme manipulations of the operator's wrist and arm.

Also, the bevel angle locking actuator 290 is easily visible to the operator when using the saw. A visual confirmation that the bevel angle of the saw is locked can be obtained by a quick glance at the position of the bevel angle locking actuator 290. When the bevel angle locking actuator was mounted at the rear of the saw, some compound miter saws prevented an easy view of its position and no way to visually confirm that the bevel angle was locked.

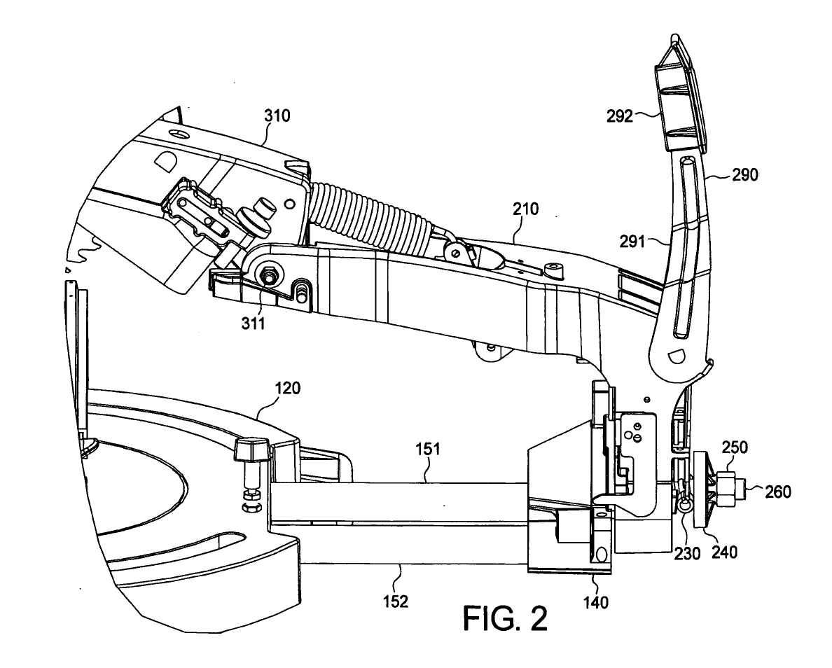

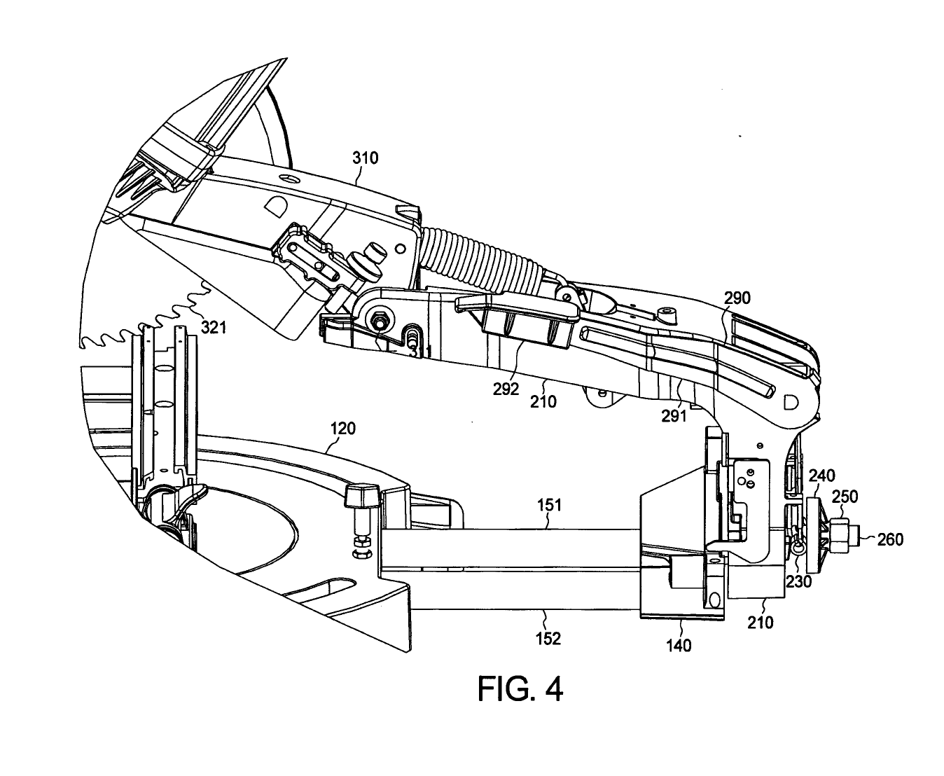

The illustrative embodiment of the bevel angle locking actuator 290 comprises an elongated lever 291 and a handle 292. The elongated lever 291 can be stamped from sheet metal such as aluminum sheet or steel sheet. The handle 292 can be formed of injection molded plastic. The bevel angle locking actuator 290 could also comprise a rotating handle or knob, or any other actuator desirable for the particular application. The lever 291 is advantageous in that it provides a long lever arm so that a relatively large amount of force can be brought to bear in the bevel angle locking system to lock the bevel angle with only a relatively small force applied to the lever. It would be difficult to position a long lever at the rear of a compound miter saw as it would likely project far out from the profile of the saw and be damaged or inadvertently unlocked when the saw is transported. With the saw support assembly mounted arrangement of bevel angle locking actuator 290, however, the lever 291 can be shaped to match and closely conform to the profile of lower arm 210. Thus, the lever 291 can be more protected from inadvertent actuation and damage, and be less obtrusive and more compact. As seen in FIG. 4, the lever 291 can be arranged so that when it is in its locked position, the longitudinal axis of the lever is generally parallel with the immediately surrounding structure of lower arm 210. As seen in FIG. 2, when the lever 291 is unlocked, the longitudinal axis of the lever can be generally vertical to give the operator a strong visual cue that the bevel angle is unlocked.

A bevel angle locking actuator mounted to the saw support assembly can be used to actuate any appropriate type of bevel angle locking system. One bevel angle locking system which works well with a saw support assembly mounted bevel angle locking actuator is shown on the compound miter saw in FIGS. 1-6. However, this illustrative embodiment of a bevel angle locking system is not the only system which can be used with a saw support assembly mounted bevel angle locking actuator.

In the illustrative embodiment of the bevel angle locking system, the male conical surface 221 and the female conical surface 141 are compressed together in order to lock the position of the saw support assembly 200 relative to the base assembly 100 and lock the bevel angle. This is done by sliding a bevel locking linkage 230 to wedge the bevel locking linkage between two surfaces causing the male conical surface 221 and the female conical surface 141 to be pushed together. In this exemplary embodiment, sliding the bevel locking linkage 230 causes it to be wedged between cam surfaces 223 formed on the trunnion insert 220, and a bevel locking flange 240. The bevel locking flange 240 abuts a nut 250 threaded onto a pin or bolt 260. Bolt 260 is approximately coaxial with the first rotational axis of the saw support assembly 200. Bolt 260 is anchored to the knuckle 140 and passes through the knuckle and through the lower arm 210 and the trunnion insert 220. When the bevel locking linkage 230 is wedged between cam surfaces 223 and bevel locking flange 240, the bevel locking linkage pushes the trunnion insert 220 into firm engagement with the knuckle 140. A reaction force causes the bevel locking linkage 230 to push against the bevel locking flange 240. Bevel locking flange 240 in turn pushes against nut 250. Nut 250 in turn pulls on and tensions bolt 260. Bolt 260 is anchored to the knuckle 140.

In the illustrative embodiment of the bevel angle locking system, the bevel locking linkage 230 moves almost in a straight line motion in a direction approximately normal to the longitudinal axis of bolt 260. In other embodiments, the linkage could move in different directions, and even in pivoting or other curved motions. In the illustrative embodiment of the bevel angle locking system, the cam surfaces are formed on trunnion insert 220. In other embodiments, the angled cam surfaces could be formed on other structure of the saw support assembly 200, or could be formed on the bevel locking flange 240, or even on the bevel locking linkage 230 itself. In other embodiments, the bevel locking flange 240 may be integrally formed with the nut 250, or the bevel locking flange 240 may be attached to the bolt 260 in some other appropriate manner.

In another embodiment, a bevel locking linkage could be wedged against a flange connected to a second shaft, a shaft parallel to the bolt 260 but spaced laterally therefrom. U.S. Pat. No. 5,425,294 shows a miter saw design with two shafts, a first shaft 4 and a second shaft connected to handle 5. In the '294 patent, handle 5 is turned to push the saw support assembly against the base assembly. A bevel locking linkage could be associated with the second shaft in the '294 patent so that when the linkage slides and is wedged, the second shaft will be tensioned and the bevel angle will be locked. However, compression of the saw support assembly 200 against the base assembly 100 around and at the bolt 260 is thought to be the best option leading to the most consistent alignment of the saw blade 321 with the base assembly 100. Because the bolt 260 is coaxial with the axis of rotation of the saw support assembly 200, pushing against the saw support assembly 200 evenly around the bolt 260 balances and centers the force of the saw support assembly 200 against the base assembly 100 and helps to ensure the most accurate alignment of the two assemblies.

The bevel locking linkage 230 is caused to slide by a slider-crank mechanism comprising a crank shaft 270. Crank shaft 270 is rotationally supported by the lower arm 210 of saw support assembly 200 and includes an eccentric shaft portion 271. The eccentric shaft portion 271 is linked to the bevel locking linkage 230. The bevel locking linkage 230 has a curved portion 231 on the end thereof which creates a pocket into which the eccentric shaft portion 271 fits. The eccentric shaft portion 271 is retained in the pocket by a block 232 which is attached to the bevel locking linkage 230 with a fastener (not shown).

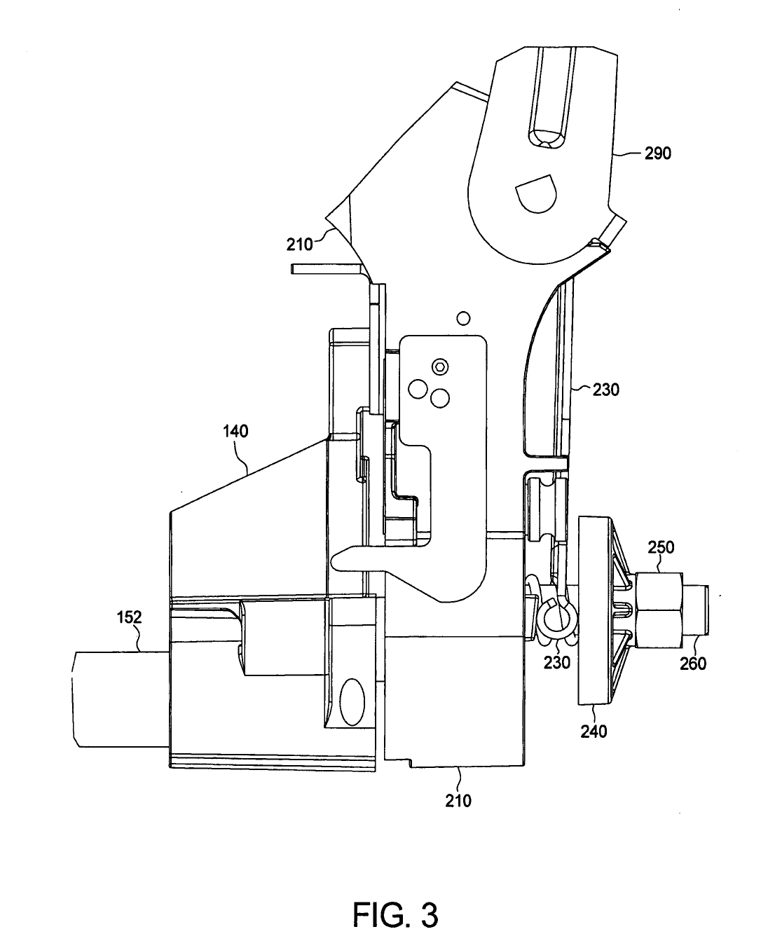

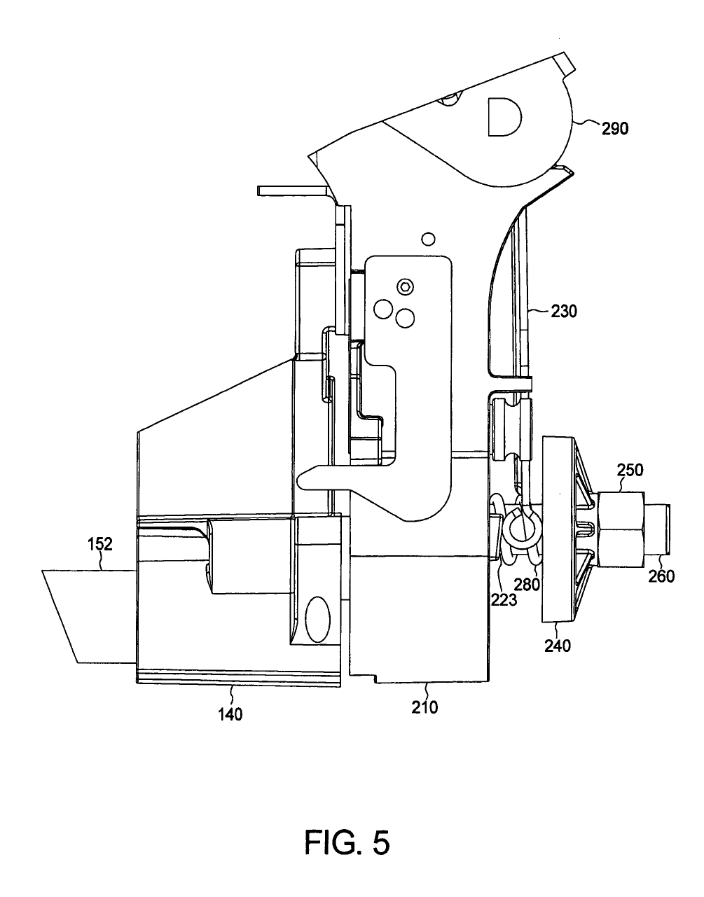

One end of crank shaft 270 is fixed to the bevel angle locking actuator 290. As the operator pivots the bevel angle locking actuator 290, the crank shaft 270 rotates and the bevel locking linkage 230 is caused to slide up and down. FIG. 2 shows the bevel angle locking actuator 290 in the unlocked or up position where the bevel locking linkage 230 is pushed downward and the bevel angle is unlocked. FIG. 3 is a detail, plan view of the bevel angle locking actuator 290 and the bevel locking linkage 230 in the position shown in FIG. 2. A spring 280 (see FIGS. 5 and 6) can be positioned between the trunnion insert 220 and the bevel locking flange 240. In this unlocked position, the spring 280 ensures a sufficient amount of force against the saw support assembly 200 to keep the saw support assembly 200 from disengaging too much from the base assembly 100 so that the operator does not feel too much play between the saw support assembly and the base assembly when the bevel angle is unlocked.

FIG. 4 shows the bevel angle locking actuator 290 in the locked or down position where the bevel locking linkage 230 is pulled upward and the bevel angle is locked. FIG. 5 is a detail, plan view of the bevel angle locking actuator 290 and the bevel locking linkage 230 in the position shown in FIG. 4.

This embodiment of a bevel angle locking system has several advantages over prior art systems. First, this embodiment permits mounting the actuator for the system somewhere other than at the rear of the saw. Second, the force of the saw support assembly 200 against the base assembly 100 is approximately evenly balanced around the first rotational axis of the saw support assembly to ensure consistent and accurate placement of the saw blade 321 relative to the base assembly and the workpiece. Third, this system is capable of holding the bevel angle and the saw support assembly firmly.

The principles of the inventive bevel angle locking actuator and bevel angle locking system have been described through a description of and through reference to drawings illustrating illustrative embodiments. The principles of the invention are applicable to produce other embodiments, dissimilar in some respects to the illustrative embodiments, to fit particular needs. The scope of invention protected hereby is not limited to the illustrative embodiments.

We claim:

1. A saw comprising:
a base assembly with a top surface;
a saw support assembly rotatably mounted to the base assembly to rotate relative to the base assembly about a first rotational axis;
a saw unit having a saw blade defining a cutting plane that is approximately parallel to the first rotational axis, the saw unit supported by the saw support assembly above the top surface, the saw unit and the saw support assembly rotating together about the first rotational axis to adjust the bevel angle of the saw blade;
a slide mechanism attached to the saw support assembly, whereby enabling the saw blade to translate relative to the top surface; and
a bevel angle locking actuator mounted to the saw support assembly, wherein the bevel angle locking actuator rotates approximately in parallel with the saw support assembly about the first rotational axis when the bevel angle of the saw blade is adjusted, and wherein the bevel angle is capable of being adjusted by a user when the bevel angle locking actuator is in an unlocked position and the bevel angle cannot be adjusted by a user when the bevel angle locking actuator is in a locked position.

2. The saw of claim 1 wherein pivoting the bevel angle locking actuator to the locked position causes a surface of the saw support assembly to be moved against a surface of the base assembly to increase the pressure between the surfaces, the increased pressure resulting in increased friction which resists rotation of the saw support assembly relative to the base assembly.

3. The saw of claim 1 wherein the bevel angle locking actuator is pivotally mounted to the saw support assembly to pivot about an axis approximately normal to the first rotational axis, the bevel angle locking actuator pivoting relative to the saw support assembly between its locked position and unlocked position.

4. The saw of claim 1 wherein the bevel angle locking actuator is pivotally mounted to the saw support assembly and pivots about a pivoting axis relative to the saw support assembly between its locked position and unlocked position.

5. The saw of claim 4 further comprising:
an eccentric surface eccentrically formed from the pivoting axis of the bevel angle locking actuator, the eccentric surface being operatively connected to the bevel angle locking actuator; and
a linkage, wherein pivoting of the bevel angle locking actuator to the locked position causes the eccentric surface to pivot, the pivoting of the eccentric surface driving a movement of the linkage, the movement of the linkage pushing a surface of the saw support assembly against a surface of the base assembly to lock the bevel angle.

6. The saw of claim 1 wherein the bevel angle locking actuator comprises an elongated lever.

7. The saw of claim 6 wherein the elongated lever is formed from stamped sheet metal.

8. The saw of claim 6 wherein the saw support assembly comprises a lower arm, and when the bevel angle locking actuator is in the locked position, the elongated lever extends generally parallel to the lower arm.

9. The saw of claim 1 wherein the slide mechanism comprises two slide rods slidably mounted to the base assembly.

10. The saw of claim 1 wherein the slide mechanism is fixedly amounted to the base assembly with the saw support assembly slidably mounted thereon.

11. A saw comprising:
a base assembly with a top surface;
a saw unit having a saw blade capable of turning about a first rotational axis;
a saw support assembly rotatably mounted to the base assembly, the saw support assembly rotating relative to the base assembly about a second rotational axis to adjust the bevel angle of the saw blade, and the saw support assembly supporting the saw unit and pivoting the saw unit above the base assembly;
a slide mechanism attached to the saw support assembly, whereby enabling the saw blade to translate relative to the top surface;
a bevel angle locking actuator pivotally mounted to the saw support assembly, the bevel angle locking actuator pivoting relative to the saw support assembly about a third rotational axis not parallel with the second rotational axis.

12. The saw of claim 11, wherein the third rotational axis is approximately perpendicular to the first rotational axis.

13. The saw of claim 11, wherein the third rotational axis is a pivoting axis to allow the bevel angle locking actuator pivot between its locked position and unlocked position.

14. The saw of claim 13, further comprising:
an eccentric surface eccentrically formed from the pivoting axis of the bevel angle locking actuator, the eccentric surface being operatively connected to the bevel angle locking actuator; and
a linkage;
wherein pivoting of the bevel angle locking actuator to the locked position causes the eccentric surface to pivot, the pivoting of the eccentric surface driving a movement of the linkage, the movement of the linkage pushing a surface of the saw support assembly against a surface of the base assembly to lock the bevel angle.

15. The saw of claim 11, wherein the slide mechanism comprises two slide rods slidably mounted to the base assembly, the two slide rods are adapted to turn about the first rotational axis in parallel with the saw blade.

16. The saw of claim 11, wherein the slide mechanism is fixedly mounted to the base assembly, and the saw support assembly slidably mounted on the slide mechanism.

17. A saw comprising:
a base assembly with a top surface;
a saw unit having a saw blade;
a saw support assembly rotatably mounted to the base assembly, the saw support assembly supporting the saw unit and pivoting the saw unit relative to the base assembly, the saw support assembly rotating relative to the base assembly about a first rotational axis to adjust a bevel angle of the saw blade;
a slide mechanism attached to the saw support assembly, whereby enabling the saw blade to translate relative to the top surface;
a first bevel locking linkage attached to the saw support assembly, the bevel locking linkage being adapted to translate in a direction normal to the first rotational axis, the translation of the first bevel locking linkage causing the saw support assembly to be pushed against the base assembly creating friction which prevents relative rotation of the saw support assembly.

18. The saw of claim 17, further comprising a second bevel locking linkage pivotally mounted to the saw, the translation of the first bevel locking linkage applying forces to pivot the second bevel locking linkage about a second rotational axis, the pivoting of the second bevel locking linkage causing a surface of the saw support assembly to be pressed against a surface of the base assembly to lock the bevel angle with friction.

19. The saw of claim 18, wherein the second rotational axis is approximately normal to the first rotational axis.

20. The saw of claim 17, wherein the base assembly further comprises a base and a turntable rotatably mounted on the base to turn about an axis normal to the first rotational axis and normal to the top surface.

21. A saw comprising:
a base assembly having a top surface;
a saw unit having a saw blade turning to cut a workpiece;
a saw support assembly rotatably mounted to the base assembly, the saw support assembly rotating relative to the base assembly about a first rotational axis to adjust the bevel angle of the saw blade, and the saw support assembly supporting the saw unit;
the saw support assembly further comprising a lower arm and an insert attached to the lower arm, the insert being made of a different metal than the lower arm, wherein the insert extends from the saw support assembly, and contacts and moves relative to the base assembly when the bevel angle is adjusted; and
a slide mechanism attached to the saw support assembly, whereby enabling the saw blade to translate relative to the top surface.

22. The saw of claim 21, further comprising:
a first surface formed on the base assembly and a second surface formed on the saw support assembly wherein when the second surface is pressed against and engaged with the first surface, the bevel angle of the saw blade is locked; and
at least a portion of the second surface is formed on the insert.

23. The saw of claim 21, wherein the insert is attached to the lower arm with fasteners.

24. The saw of claim 21, wherein the first and second surfaces are a pair of mating male and female conical surfaces.
